(19) United States
(12) Patent Application Publication
(10) Pub. No.: US 2011/0247667 A1
(43) Pub. Date: Oct. 13, 2011

(54) Coffee Crutch

(76) Inventor: Donna Ford, Malibu, CA (US)

(21) Appl. No.: 12/692,633

(22) Filed: Apr. 12, 2010

(51) Int. Cl. A45B 3/00; A61H 3/02

(52) U.S. Cl. 135/66

(57) ABSTRACT

This invention is one piece molded coffee holder made out of plastic, rubber or any other molded material which will snap onto the crutch. The coffee holder snaps onto the crutch via 2 molded c-shaped protrusions on both sides of the holder which snap onto the 2 side rails of the crutch and is located between the intersection of the rails at the bottom half of the crutch and the hand bar of the crutch so that the holder sits securely in between the 2 side rails of the crutch and does not interfere with the use of the crutches and/or the crutch hand bar or bump into the user of the crutches while transporting coffee. The coffee holder has a vertical slot on the outside of the holder which is 1.5″ long, and 1″ wide at the top and tapering to 0.75″ wide at the bottom so that it can easily hold a coffee mug, cup or travel mug with a handle, as well as any disposable coffee cup, of any height or size, and the entire holder is slightly tilted with the outward edge lower than the inside edge to prevent any spilled coffee from getting on the users clothes during transit so that the coffee holder securely holds and carries coffee around the home or office while on crutches with minimal spillage on the user.

The “Coffee Crutch” is a one piece molded coffee holder with a slot on one side to hold a coffee mug or cup with a handle, a travel mug with a handle, or a disposable coffee cup. The Coffee Crutch is tilted slightly to avoid spilling coffee on the crutch user's clothes while transporting the coffee on crutches, so that any spilled coffee will spill from the side of the holder which is located on the outside of the crutch. The Coffee Crutch is snapped onto the crutch via 2 c-shaped protrusions (6) on both sides of the holder, so that the holder sits in between the 2 crutch rails (1) of the crutch and does not interfere with the use of the crutch hand bar. The Coffee Crutch can carry coffee, beverages, and any number of other objects, around the home or office while on crutches, including a coffee mug or cup with a handle, a travel mug, a disposable coffee cup of any size, or any other type of bottle or beverage cup or container, or other small items and papers. The Coffee Crutch can be made out of molded plastic, rubber, or any other molded material which will snap onto the crutch.

The Coffee Crutch is a molded coffee holder open on both the top end and the bottom end (see FIGS. 3, 4) to accommodate any travel or regular coffee mug or cup with a handle, or any disposable coffee cup of any size. The Coffee Crutch measures approximately 3.25″ in diameter at the top and approximately 2.75″ in diameter at the bottom, tapering from the top to the bottom, and is approximately 2.25″ in height, with a vertical slot (3) of 1.5″ long, which is 1″ wide at the top and 0.75″ at the bottom. The vertical slot (3) is located on one side to accommodate the handle of a coffee mug or a travel mug (see FIG. 1). The Coffee Crutch is slightly tilted with the outward edge (4) approximately 0.25″ lower than the inside edge (5) to prevent any small amount of spilled coffee from getting on the clothes of the crutch user during transit (see FIG. 2). The Coffee Crutch has 2 molded c-shaped protrusions (6) on both sides of the holder which are approximately 0.75″ in height and 0.75″ in diameter which snap onto the 2 side rails (1) of the crutch (see FIGS. 3, 4) just above the curve at the bottom half of the crutch, approximately 7″ above the crutch joint (2) and approximately 7″ below the crutch hand grip at its highest level, and varying heights when the hand grip is adjusted or set lower.

Any variety of other items can be carried in the coffee Crutch holder in addition to coffee mugs or cups, including canned drinks, Styrofoam, paper or plastic beverage holders, bottled beverages, water bottles or rolled or folded papers from trips to the mailbox or around the home or office, cell phones or other electronic hand held devices.

The Inventor was on crutches for approximately 4 months and needed to carry coffee to the office and around the home while on crutches without the use of hands, without relying on others to carry items for her, and with minimal spillage. With assistance from her 8 year old son Jack, who wants to be an inventor when he grows up, the Inventor used packing tape on her first day on crutches to hold a plastic cup holder from her son Jack's seat in the family van, and modified the holder to use temporarily while on crutches. The hope is to manufacture a simple “snap on” molded coffee holder for other coffee drinkers to use while on crutches for any period of time. The holder can be easily snapped on and off, and in fact, used on either or both crutches. The Coffee Crutch can be made out of molded plastic, rubber, or any other molded material which will snap onto the crutch. Jack and the Inventor are very excited about their first invention and Jack insisted that inventor file for a patent on the new invention created by her with her son Jack's assistance.

### BACKGROUND OF THE INVENTION

The Inventor was on crutches for over 4 months and needed to have her coffee every morning and to carry coffee to the office and around the home while on crutches without the use of hands, without relying on others to carry items for her, with minimal spillage, and which did not interfere with the use of the crutches or the crutch hand bar. With assistance from Inventor's 8 year old son Jack, who wants to be an inventor when he grows up, the Inventor used packing tape on her first day on crutches to hold a plastic cup holder from her son Jack's seat in the family van, and modified the holder to use temporarily while on crutches to carry Inventor's coffee to the office and around the home so that it would carry a mug or cup with a handle, a travel mug, and any disposable coffee cup of any size. The hope is to manufacture a simple “snap on” molded coffee mug and cup holder for all coffee drinkers to use while on crutches for any period of time. The holder can be easily snapped on and off, and in fact, used on either or both crutches, and can be made out of plastic, rubber, or any other molded material which will snap onto the crutch. Jack and Inventor are very excited about their first invention and Jack insisted that Inventor file for a patent on the new invention which was created by her with her son Jack's assistance. There are no prior art problems and no known references related to this invention.

### BRIEF SUMMARY OF THE INVENTION

This patent application is for a one piece molded coffee holder, made out of plastic, rubber, or any other molded material, which snaps onto the crutch by two c-shaped protrusions on each end of the holder so that the holder sits in between the 2 rails of the crutch and does not interfere with the use of the crutch hand bar or bump into the crutch user, and which will carry a coffee mug, cup or travel mug with a handle, as well as a disposable coffee cup of any size, or other beverage container or item while on crutches and without the use of hands to hold the beverage, and which is tilted slightly to minimize the spilling of coffee on the user of the crutches, and which has a vertical slot feature on one side to accommodate the handle of a coffee mug, cup or travel mug so that the coffee mug fits securely into the holder without falling out of the holder.

### BRIEF DESCRIPTION OF THE SEVERAL VIEWS OF THE DRAWINGS

FIG. 1 is a plan view of the outward facing side of a crutch having the Coffee Crutch holder of the present invention;

FIG. 2 is a plan view of the inside facing side of a crutch having the coffee crutch holder of the present invention;

FIG. 3 is a plan view of the top of the coffee crutch holder of the present invention;

FIG. 4 is a plan view of the bottom of the coffee crutch holder of the present invention.

### DETAILED DESCRIPTION OF THE INVENTION

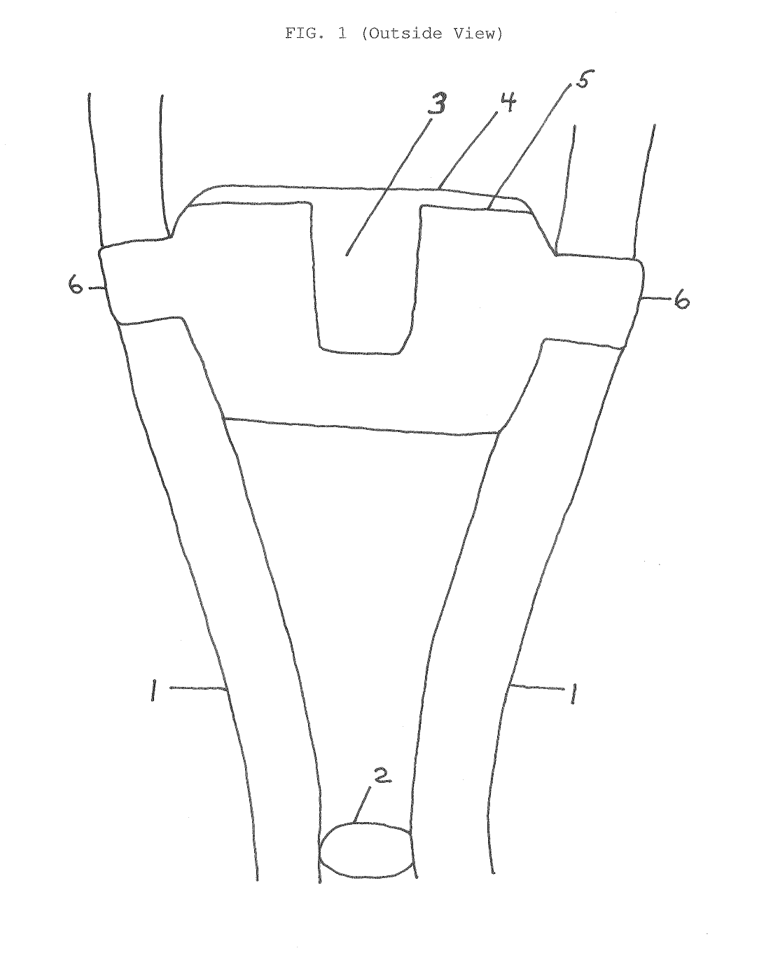

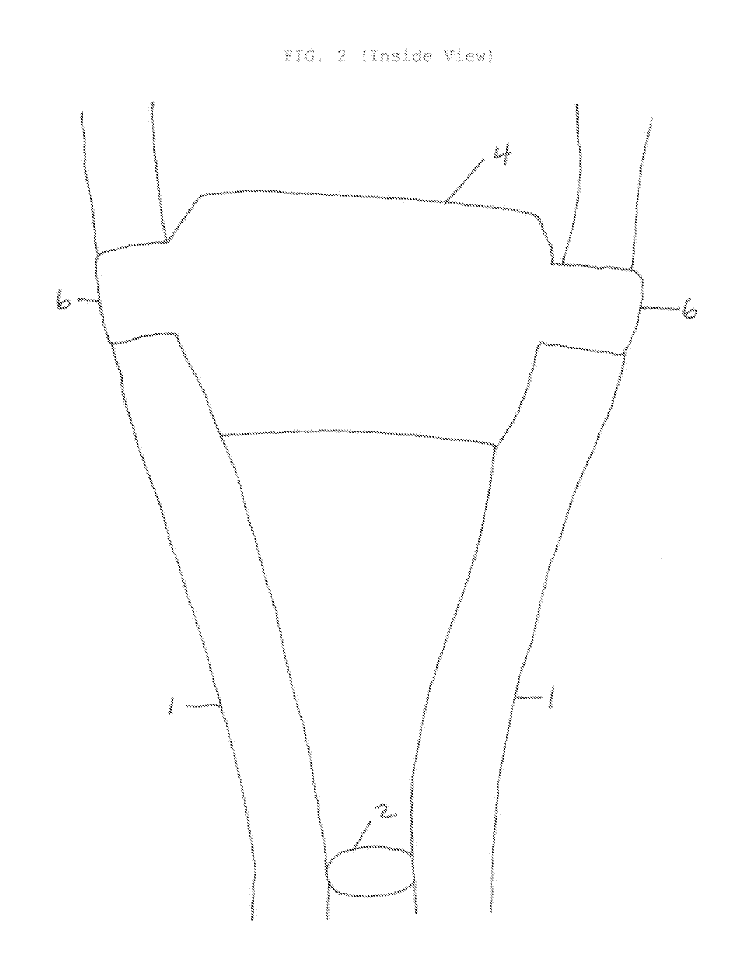

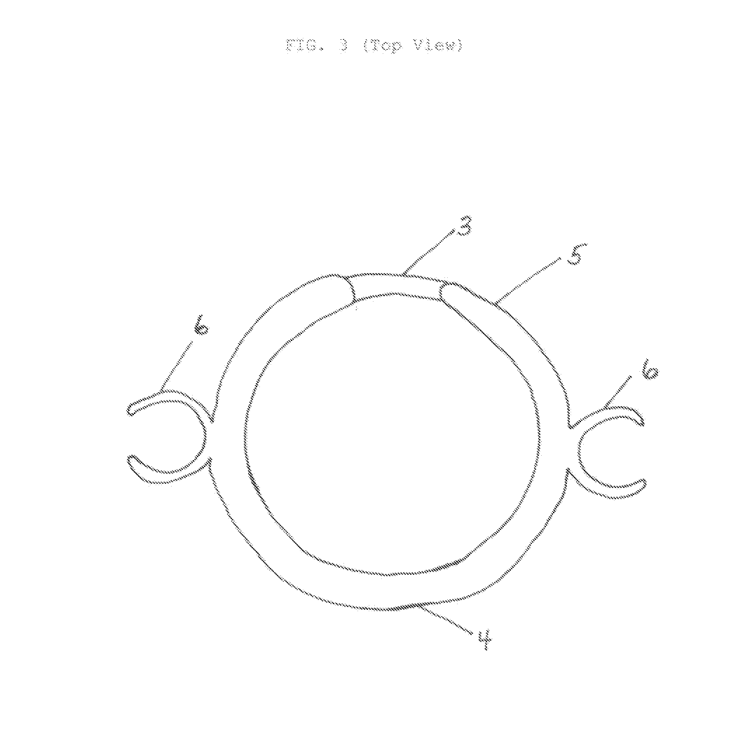

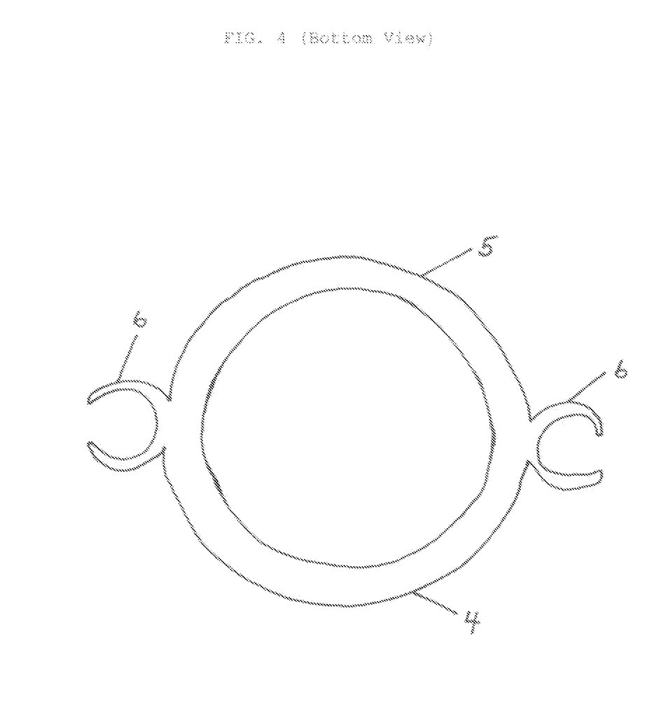

FIG. 1 is a plan view of the outward facing side of a crutch having the Coffee Crutch holder of the present invention. The Coffee Crutch holder measures approximately 3.25″ in diameter at the top and approximately 2.75″ in diameter at the bottom so that it tapers from the top to the bottom, and approximately 2.25″ in height, with a vertical slot (3) of 1.5″ long, and 1″ wide at the top and 0.75″ wide at the bottom, with the vertical slot (3) located on one side to accommodate the handle of a coffee mug or cup, or a travel mug (see FIG. 1). FIG. 2 is a plan view of the inside facing side of a crutch having the Coffee Crutch holder of the present invention. The Coffee Crutch holder is slightly tilted with the outward edge (4) approximately 0.25″ lower than the inside edge (5) to prevent any coffee spillage from getting on the clothes of the crutch user during transit (see FIG. 2). FIG. 3 is a plan view of the top portion of the Coffee Crutch holder of the present invention. The Coffee Crutch holder is a molded coffee holder open on both the top end and the bottom end (see FIGS. 3, 4) to accommodate a coffee mug or cup, a travel mug, or a disposable coffee cup of any height or size. The Coffee Crutch has 2 molded c-shaped protrusions (6) on both sides which are approximately 0.75″ in height and approximately 0.75″ in diameter, and which snap onto the 2 side rails (1) of the crutch (see FIGS. 3, 4) just above the curve at the bottom half of the crutch approximately 7″ above the crutch joint (2), and approximately 7″ below the hand grip at its highest level, and varying heights when the hand grip is adjusted or set lower, so that the Coffee Crutch holder sits in between the 2 rails of the crutch (see FIGS. 1, 2, 3, 4). FIG. 4 is a plan view of the bottom of the Coffee Crutch holder of the present invention which is open at the top and the bottom.

I claim:

1. A Coffee Crutch comprising: An attachment for a crutch consisting of a one piece molded coffee holder, made out of plastic, rubber or any other molded material, and
which snaps onto the crutch via 2 molded c-shaped protrusions on both sides of the holder which snap onto the 2 side rails of the crutch between the intersection of the rails at the bottom half of the crutch and the hand bar of the crutch so that the holder sits in between the 2 side rails of the crutch and does not interfere with the use of the crutches and/or the crutch hand bar, and
which has a vertical slot on the outside of the holder which is 1.5″ long, and 1″ wide at the top and tapering to 0.75″ wide at the bottom so that it can easily hold a coffee mug, cup or travel mug with a handle, as well as a disposable coffee cup, of any height or size, and
the entire holder is slightly tilted with the outward edge lower than the inside edge to prevent any spilled coffee from getting on the users clothes during transit, so that the coffee holder securely holds and carries coffee around the home or office while on crutches with minimal spillage on the user.
